(19) United States
(12) Patent Application Publication
(10) Pub. No.: US 2022/0274789 A1
(43) Pub. Date: Sep. 1, 2022

(54) PULLNOSE BELT

(71) Applicant: ROTZINGER AG, Kaiseraugst (CH)

(72) Inventor: Kurt PHILIPP, Grenzach-Wyhlen (DE)

(73) Assignee: ROTZINGER AG, Kaiseraugst (CH)

(21) Appl. No.: 17/608,821

(22) PCT Filed: May 6, 2020
(86) PCT No.: PCT/EP2020/062519

§ 371 Date: Nov. 8, 2021

(30) Foreign Application Priority Data
May 6, 2019 (CH) 00597/19

(51) Int. Cl. B65G 47/94; B65G 21/02; B65G 23/06

(52) U.S. Cl. CPC B65G 47/945; B65G 21/02; B65G 23/06; B65G 2207/26

(57) ABSTRACT

In a pullnose belt with a chassis, the chassis is supported on the ground on a fixed side of the belt and projects freely on the opposite free side. Drive and deflector rollers, over which the endless belt runs, are mounted in said chassis. One deflector roller is arranged on the end of wing-shaped support arms projecting from a point of fixing to a horizontally displaceable carriage.

The invention relates to a pullnose belt according to the preamble of patent claim 1.

In the production of chunky frozen food products, above all those with egg white and fat content, a high hygiene standard is prescribed, which also extends to the product conveying systems. Specially designed conveyor belts are required for this purpose. These conveyor belts must be resistant to corrosion and be able to withstand aggressive cleaning agents. The cleaning is usually carried out with hot pressurized water or superheated steam. In this case, the so-called “washdown” design is referred to here. Above all, however, it must be possible to change the conveyor belts quickly and easily for cleaning.

In a conventional arrangement of conveyor belts between a production plant and one or more packaging plants, the products are removed from the production plant by means of a main conveyor belt in a main conveying direction and from the latter transferred to several belts, which are arranged one behind the other in the main conveying direction and which run transversely to the main conveying direction. For the transfer of the products from the main conveyor belt to the belts leading to packaging machines so-called pullnose belts are required in order to separate whole product series from the production flow on the main conveyor belt, which then guided transversely to the conveying direction to the respective packaging machines. In addition, pullnose belts are used to discharge defective products from the production flow.

Typically, the conveyor belts of the main conveyor belts have a width of 600 mm to 1600 mm. Thus, the main conveyor belts are wide belts and have large conveyor belts. A so called pullnose belt is such a wide main belt equipped with a displaceable belt nose. Generally, this belt nose is located at the outlet of the belt. The displacement of the belt nose takes place against the main conveying direction in order to open the conveying plane and to be able to remove product series from the production flow. After the removal of product series, the belt nose is again displaced in the main conveying direction in order to close the conveying plane again. As mentioned, the removal serves in particular to discharge product series in a defined manner and to deposit them onto an often-narrower conveyor belt, which is arranged below the conveying plane and which guides the product series transversely to the main conveying direction to a packaging machine. In particular embodiments, the displaceable belt nose is additionally designed to be vertically pivotable. In this case, a so-called deposit pullnose belt is referred to.

According to the prior art, in the field of the production of frozen food main belts are generally used, in which the belt change must take place upwards, since these belts have a chassis with floor support on both sides. For the belt change, all deflector rollers located within the belt must be taken out here, including the heavy drive drum and the two end deflectors as well as all the support plates lying on top, which are arranged on the entire running surface of the belt for belt support. For the removal of the drive drum, tools are usually also required and, thus, also correspondingly trained personnel. Thus, a belt change in such a classic main belt takes at least 20-30 minutes. The thus forced standstill of the main belt results in significant production loss.

The object of the present invention is to make it possible to change the belt without tools and within less than 10 minutes in the case of a pullnose belt.

According to the invention, this is achieved by a pullnose belt, which is distinguished by the features of the characterising part of the claim 1.

In the following, a preferred embodiment of the invention will be described with reference to the accompanying drawings.

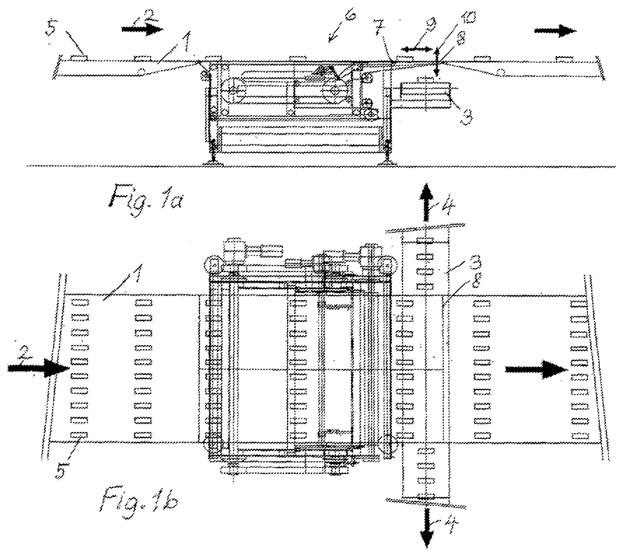

FIGS. 1 a, b show a part of a conveying device with a pullnose belt.

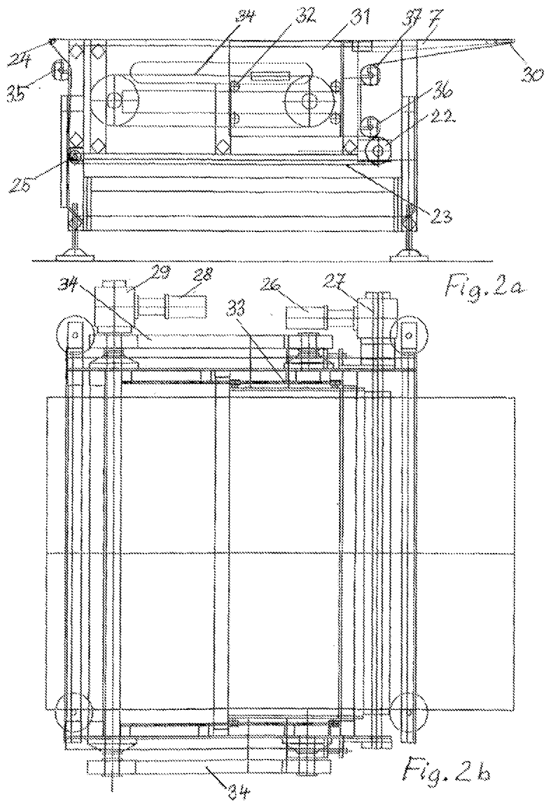

FIGS. 2 a, b show a side view and a top view of a pullnose belt according to the invention

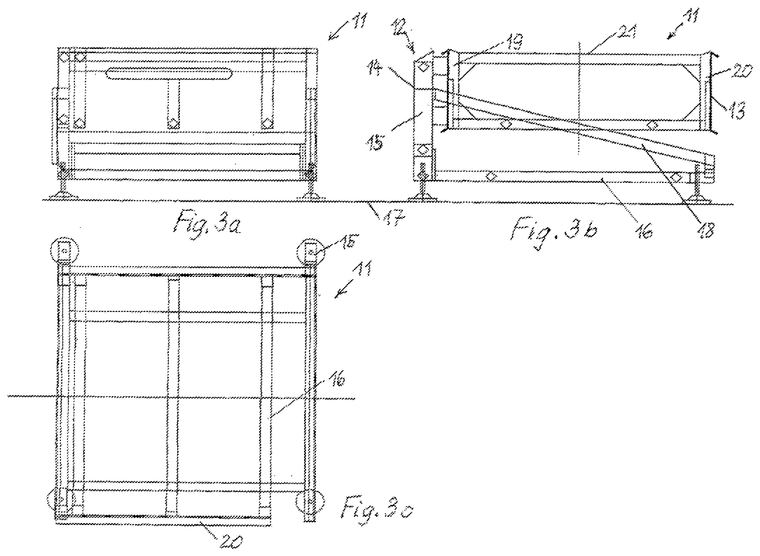

FIGS. 3 a-c show the chassis of the pullnose belt shown in FIG. 1 in three views

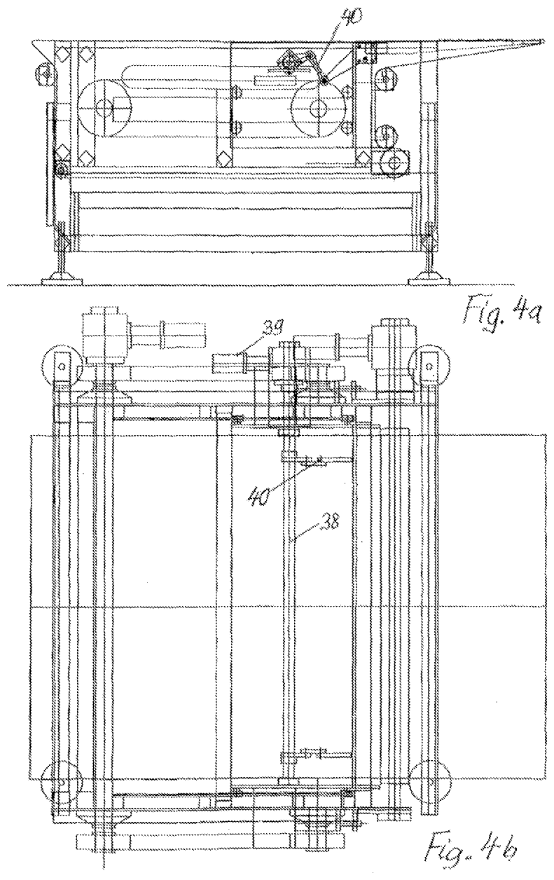

FIGS. 4 a, b show a further embodiment of a pullnose belt.

In the part of a conveying device shown in FIG. 1, a main conveying line 1 runs according to the arrows 2 and a discharge line 3 runs according to the arrows 4 transversely thereto. Product series 5 arrive at the main conveying line, for example, from a production plant, and individual ones of the product series are transferred by a pullnose belt 6, which is inserted into the main conveying line, to the discharge lines, from which they are conveyed, for example, to packaging stations.

At its outlet end, the pullnose belt is equipped with a pullnose 7, a belt nose 8, which projects in the main conveying direction and which is retracted against the main conveying direction for discharging of product series and then returned to the starting position, as indicated by the double arrow 9.

In the exemplary embodiment shown in this figure, according to the double arrow 10, the belt nose can also be lowered at the same time it is retracted and then be raised again. This enables the products to be deposited gently.

The pullnose belt 6 shown in FIGS. 2 and 3 has a chassis 11, which is designed in a manner of a balcony construction, i.e., there is a fixed side 12, on which the chassis is supported on the ground, and a free side 13, on which there is no support to the ground. The fixed side consists of a frame 14 of vertical supports 15 and horizontal crossmembers 16, which is supported on the ground 17, i.e., usually the floor of a production hall. Additionally, obliquely extending struts 18 are attached between the supports and the crossmembers for stiffening. A chassis plate 19 is attached at this frame. The free side consists of a chassis plate 20, which has no connection to the ground and is connected to the supports on the fixed side by means of crossmembers 21.

The drive drum 22 for the belt 23, an inlet-side deflector roller 24, and a lower deflector roller 25, as well as the guide devices of the pullnose mechanics are attached at the chassis plates. A drive motor 26 with a transmission 27 for the belt drive drum and a drive motor 28 with a gearbox 29 for the pullnose mechanics are arranged at the outer side of the chassis plate on the fixed side.

The pullnose consists of a flat, wing-shaped outlet belt deflector 30, which is arranged at a carriage 31, which is displaceable in parallel to the main conveying direction.

The carriage is provided with guide rollers 32 which run on guide rails 33. The guide rails are mounted on both sides and on the inner sides of the chassis plates of the fixed side and the free side. The carriage is driven by revolving toothed belts 34, which are arranged on both sides and on outer sides of the chassis plates of the fixed side and the free side. The drive motors for the belt and the pullnose carriage are servo motors.

As best seen in FIG. 2a, the belt silhouette encloses the complete drive and guide mechanics with the exception of the three outer deflector rollers 35, 36, 37 so that the endless belt, after it is relaxed and the three outer deflector rollers are removed, can simply be pulled out on the free side through the open chassis. The removal of the outer deflector rollers is simple and doable without tools since the rollers are only loosely inserted into the chassis on both sides.

Additionally, further features of this pullnose belt are a short overall length in combination with a small overall height of the chassis body and a large pullnose stroke width with a short overall length. For this purpose, the shaping of the belt silhouette is decisive. A belt silhouette which is as flat as possible enables a small overall height. For this reason, the belt drive is arranged in the lower outlet region of the pullnose belt. The drive roller is displaceable transversely to its axis in the horizontal direction so that the belt can be tensioned and relaxed without an additional tensioning roller being required for this purpose. For this purpose, electric spindle drives are arranged on both sides, by means of which spindle drives the drive roller can be moved accordingly. The belt running control can also be realized with these drives. If the belt runs off towards the one or the other side, the drive drum can be inclined accordingly so as to counteract the runoff. It is thus also possible to dispense with a separate control roller for the belt running control.

Overall, the belt silhouette is determined by four inner deflector rollers and three outer deflector rollers. Two outer deflector rollers 36, 37 are connected to the carriage of the pullnose and pull the belt according to the movement of the pullnose.

In addition to the horizontal movement of the pullnose, in the exemplary embodiment shown in FIG. 4, the flat wing-shaped belt deflector of the pullnose can also be pivoted vertically. In this way, a so-called deposit pullnose belt, with which product series can be removed from the flow and deposited in a defined and gentle manner on a below lying discharge belt. These product series are then conveyed transversely to the conveying direction to the packaging machine. This vertical pivoting movement takes place by means of a shaft 38, which is on the one hand connected to a drive 39, which is arranged at the outside of the fixed side and connected to the pullnose carriage via a console, and which is on the other hand connected to the wing-shaped belt nose via a linkage 40.

The upper belt deflector at the inlet of the pullnose belt can likewise be designed as a flat, wing-shaped belt deflector.

This pullnose belt can also be utilised with a reversible operated belt. In this case, the wing-shaped belt deflector is located at the inlet of the belt. Likewise, the drive roller is then located below the belt inlet. In this reversed operating mode, the wing-shaped belt deflector can also be designed to be vertically pivotable.

1. A pullnose belt with a chassis, which is supported on a ground, drive and deflector rollers, which are supported in the chassis, and an endless belt, which is running over the rollers, wherein a deflector roller is arranged at the end of wing-shaped projecting support arms, which are attached to a horizontally displaceable carriage, wherein the chassis is supported on the ground on a fixed side of the belt and projects freely on the opposite free side.

2. The pullnose belt according to claim 1, wherein the entire drive and guide devices are located inside the belt silhouette with the exception of easily inserted deflector rollers.

3. The pullnose belt according to claim 1, wherein one of the rollers is a drive drum for the endless belt and the drive drum is connected to a drive, which is arranged at the outside of the fixed side.

4. The pullnose belt according to claim 1, wherein the fixed side of the chassis consists of vertical supports, horizontal crossmembers, obliquely extending struts, and a chassis plate, which is arranged on the vertical supports.

5. The pullnose belt according to claim 1, wherein the free side consists of a chassis plate, which connected to the fixed side by crossmembers.

6. The pullnose belt according to claim 1, wherein the carriage runs on guide rails, which are arranged at the chassis plates.

7. The pullnose belt according to claim 1, wherein the carriage is moved by means of toothed wheels and toothed belts, which are arranged on both sides outside the chassis plates and are driven by a drive motor arranged outside the fixed side.

8. The pullnose belt according to claim 1, wherein the wing-shaped support arms are connected via a linkage to a shaft mounted in the carriage and the shaft is connected to a drive motor, which is arranged outside the fixed side, by means of which the shaft is rotated into defined angular positions for tilting the deflector roller, which is arranged at the end of the support arms.
